(19) United States
(12) Patent Application Publication
(10) Pub. No.: US 2005/0122312 A1
(43) Pub. Date: Jun. 9, 2005

(54) Self-inflating mouse device

(75) Inventors: Hsun-Li Huang, Hsinchu City (TW); Chun-Hsjung Yin, Tainan (TW); Chih-Wei Wu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BenQ Corporation

(21) Appl. No.: 11/003,072

(22) Filed: Dec. 3, 2004

(30) Foreign Application Priority Data
Dec. 5, 2003 (TW) 92134465

(51) Int. Cl. G09G 5/08

(52) U.S. Cl. 345/163

(57) ABSTRACT

A self-inflating mouse device includes a mouse body and an extension part. The mouse body includes a bottom surface and a side protrusion. The extension part that may be expandable includes an opening coupling with the side protrusion. While the extension part is expanded, the contact area between the self-inflating mouse device and an user's palm is increased. Further, while the extension part is folded, the volume of the self-inflating mouse device is reduced as a compact form being convenient for storage.

This application claims the benefit of Taiwan application Serial No. 92134465, filed Dec. 5, 2003, the subject matter of which is incorporated herein by reference.

### BACKGROUND OF THE INVENTION

1. Field of the Invention

The invention relates in general to a computer mouse device, and more particularly to a self-inflating mouse device.

2. Description of the Related Art

A computer mouse is a kind of pointing devices for computers, which effects a corresponding movement of a pointer or a cursor on the display of a computer to which the mouse is connected. With the advanced development of 3C (consuming electronics product, computer and communication) industries, the current manufactures tend to build a computer mouse with small size and light weight so that the computer mouse may be carried with ease. However, it is inconvenient for users in holding a small size computer mouse.

### SUMMARY OF THE INVENTION

In view of the foregoing, it is an object of the present invention to provide a self-inflating mouse device utilizing a self-inflating air cushion as an extension part of small-sized computer mouse. The extension part accommodates the small-sized computer mouse so as to enlarge a contact surface between the computer mouse and a user's hand and support the pressure that the user gives when the user uses the computer mouse.

The invention achieves the above-identified object by providing a self-inflating mouse device including a mouse body and an extension part. The mouse body has a bottom surface and a side protrusion. The extension part is expandable and has an opening coupling with the side protrusion. A wherein a contact area between the self-inflating mouse device and a palm of a user can be increased while the extension part is expanded, and volume of the self-inflating mouse device is reduced as a compact form being convenient for storage while the extension part is folded.

It is another object of the invention to provide a self-inflating mouse device including a mouse body and an extension part. The mouse body has a bottom surface, a side protrusion and a clicking part, and the extension part is expandable and has an opening coupling with the side protrusion. The bottom surface of the mouse body has a sensor and the clicking part and the sensor are exposed out of the extension part when the mouse body is coupled with the opening. A contact area between the self-inflating mouse device and a palm of a user can be increased while the extension part is expanded, and volume of the self-inflating mouse device is reduced as a compact form being convenient for storage while the extension part is folded.

It is another object of the invention to provide a self-inflating mouse device including a mouse body and an extension part. The mouse body has a bottom surface, a side protrusion and a clicking part, and the extension part is expandable and has a valve and an opening coupling with the side protrusion. The bottom surface of the mouse body has a sensor and the clicking part and the sensor are exposed out of the extension part when the mouse body is coupled with the opening. Air intake through the valve and the air is kept in the extension part to allow the extension part holding a steady form when the valve is closed, the extension part is pressed flat by a user's hand and the air is exhausted through the valve so that the volume of the extension part is reduced as a compact form.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a vertical view of a self-inflating mouse device according to the preferred embodiment of the present invention.

FIG. 2 is a lateral view of the self-inflating mouse device according to the preferred embodiment of the present invention.

FIG. 3 is an upward view of the self-inflating mouse device according to the preferred embodiment of the present invention.

FIG. 4 is an exploded schematic view of the self-inflating mouse device according to the preferred embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, the embodiments are provided so that this disclosure will be thorough and complete, and will fully convey the scope of the invention to those skilled in the art. Like numbers refer to like components throughout.

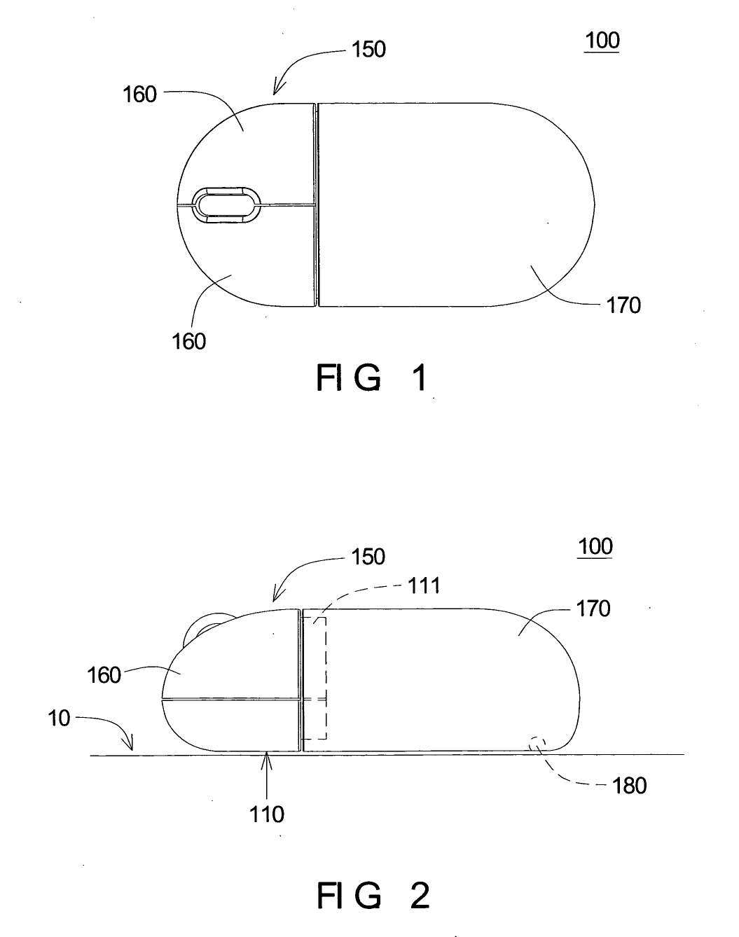

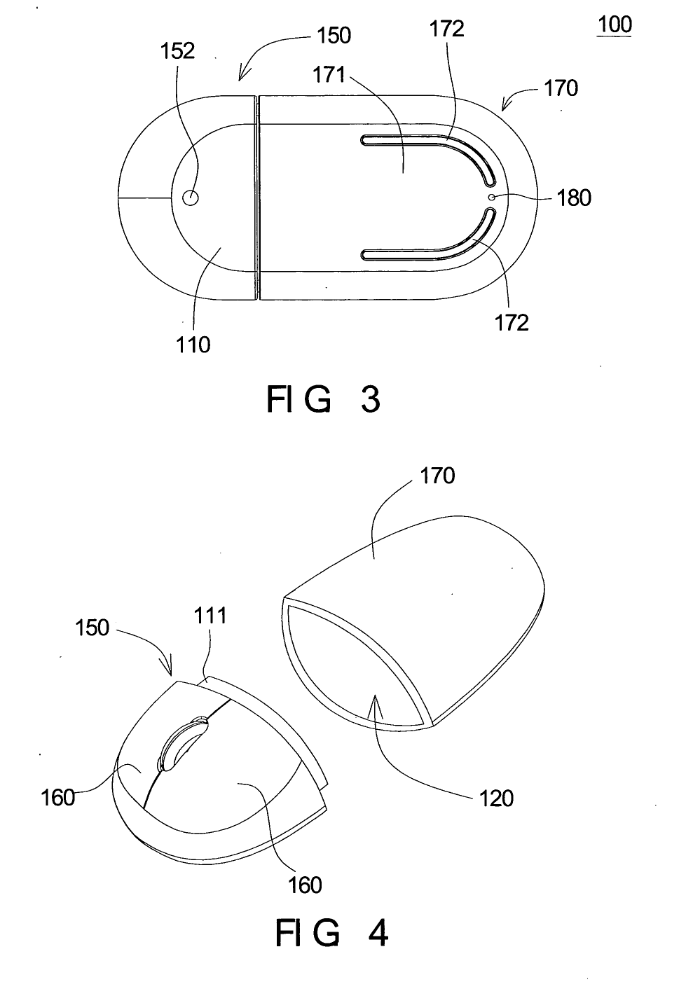

Referring all to FIG. 1, FIG. 2, FIG. 3, and FIG. 4, FIG. 1 is a vertical view of a self-inflating mouse device according to the preferred embodiment of the present invention, FIG. 2 is a lateral view of the self-inflating mouse device according to the preferred embodiment of the present invention, FIG. 3 is an upward view of the self-inflating mouse device according to the preferred embodiment of the present invention, and FIG. 4 is an exploded schematic view of the self-inflating mouse device according to the preferred embodiment of the present invention. In FIG. 1, and FIG. 2, a self-inflating mouse device 100 includes a mouse body 150 and an extension part 170. The mouse body 150 has a bottom surface 110, a side protrusion 111 and a clicking part 160. In FIG. 4, the extension part 170 has an opening 120 for coupling with the side protrusion 111. The clicking part 160 is exposed out of the extension part 170 when the side protrusion 111 of the mouse body 150 is coupled with the opening 120, so that the clicking part 160 is operated by a user's fingers to effect a corresponding movement of a pointer or a cursor on the display of a computer to which the self-inflating mouse device 100 is connected.

The extension part 170 is a self-inflating air cushion, and the self-inflating air cushion 170 has a valve 180, as shown in FIG. 3. The valve 180 is preferably disposed on the back part of the bottom 171 of the self-inflating air cushion 170. Air through the valve 180 fills the self-inflating air cushion 170 and keeps it in the maximum volume so that a contact surface between the self-inflating mouse device 100 and a user's hand is enlarged. The self-inflating air cushion 170 keeps a steady shape when the valve 180 is closed. When the valve is open, air is exhausted from the self-inflating air cushion 170 through the valve 180 by pressing the self-inflating air cushion 170 flat, so that the volume of the self-inflating air cushion 170 is reduced as a compact form.

The material of the self-inflating air cushion 170 can be polyethylene (PE), poly vinyl chloride (PVC), or other material with elasticity. Therefore, the self-inflating air cushion 170 can be pressed flat simply by a user's hand to exhaust air inside the self-inflating air cushion 170 through the valve 180. Therefore, the volume of the self-inflating air cushion 170 is reduced as a compact form for easy carrying of the self-inflating mouse device 100.

Employing the extension part 170 to couple to the small-sized mouse body 150 enlarges the contact surface between the computer mouse and a user's hand. The extension part 170 supports user's hand, and brings users more ease and comfort in using and carrying the self-inflating mouse device 100.

Referring to FIG. 3, it is an upward view of the self-inflating mouse device according to the preferred embodiment of the present invention. The self-inflating mouse device 100 disclosed in this embodiment of the present invention is suitable as an optical computer mouse without a cable, so that the bottom surface 11 of the mouse body 150 further includes a sensor 152, and preferably the sensor 152 is a optical sensor being equipped on the bottom surface 110 of the mouse body 150. When the side protrusion 111 of the mouse body 150 is coupled with the opening 120, the sensor 152 is exposed out of the extension part 170.

The self-inflating mouse device 100 disclosed in the present invention is not limited to the wireless optical computer mouse. It can be also applied to a wire computer mouse, as long as a fillister being disposed in the mouse body 150 for allowing the cable connected therewith to penetrate through. The location of the fillister is not limited in one particular site. The location can be designed based on the actual needs. Further, the bottom 171 of the extension part 170 preferrably includes a slippery pad 172 disposed thereon for helping sliding of the self-inflating mouse device 100, as shown in FIG. 3.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A self-inflating mouse device, comprising:
a mouse body, having a bottom surface and a side protrusion; and
an extension part, being expanded selectively and having an opening coupling with the side protrusion
wherein a contact area between the self-inflating mouse device and an user's palm is increased while the extension part is expanded, and volume of the self-inflating mouse device is reduced as a compact form while the extension part is folded.

2. The self-inflating mouse device according to claim 1, wherein the mouse body further comprises a clicking part and the bottom surface of the mouse body comprises a sensor so that the clicking part and the sensor are exposed out of the extension part when the mouse body is coupled with the opening.

3. The self-inflating mouse device according to claim 1, wherein the extension part further comprises a bottom and a slippery pad disposed on the bottom for helping sliding of the self-inflating mouse device.

4. The self-inflating mouse device according to claim 1, the extension part further comprising a valve for intaking and exhausting air therethrough, wherein when the valve is close, a shape of the extension part keeps unchanged, and when the valve is open, the air is exhausted from the extension part by pressing the extension part flat as a compact form.

5. The self-inflating mouse device according to claim 1, wherein the extension part is a self-inflating air cushion.

6. The self-inflating mouse device according to claim 5, wherein the material of the self-inflating air cushion is polyethylene (PE)

7. The self-inflating mouse device according to claim 5, wherein the material of the self-inflating air cushion is poly vinyl chloride (PVC)

8. The self-inflating mouse device according to claim 1, wherein the self-inflating mouse device is a wireless optical computer mouse.

9. The self-inflating mouse device according to claim 8, wherein the mouse body further comprises a clicking part and the bottom surface of the mouse body comprises an optical sensor so that the clicking part and the sensor are exposed out of the extension part when the mouse body is coupled with the opening.

10. The self-inflating mouse device according to claim 1, wherein the self-inflating mouse device is a wire mouse, the mouse body is connected with a cable, and the mouse body has a fillister for allowing the cable to penetrate through.

11. A self-inflating mouse device, comprising:
a mouse body, having a bottom surface, a side protrusion and a clicking part; and
an extension part, being expanded selectively and having an opening coupling with the side protrusion;
wherein the bottom surface of the mouse body comprises a sensor and the clicking part and the sensor are exposed out of the extension part when the side protrusion is coupled with the opening, and
wherein contact area between the self-inflating mouse device and an user's palm is increased while the extension part is expanded, and volume of the self-inflating mouse device is reduced as a compact form while the extension part is folded.

12. The self-inflating mouse device according to claim 11, wherein the extension part further comprises a bottom and a slippery pad disposed on the bottom for helping sliding of the self-inflating mouse device.

13. The self-inflating mouse device according to claim 11, the extension part further comprising a valve for intaking and exhausting air therethrough, wherein when the valve is close, shape of the extension part keeps unchanged, and when the valve is open, the air is exhausted from the extension part by pressing the extension part flat as a compact form.

14. The self-inflating mouse device according to claim 11, wherein the extension part is a self-inflating air cushion.

15. The self-inflating mouse device according to claim 14, wherein the material of the self-inflating air cushion is polyethylene (PE)

16. The self-inflating mouse device according to claim 14, wherein the material of the self-inflating air cushion is poly vinyl chloride (PVC)

17. The self-inflating mouse device according to claim 11, wherein the self-inflating mouse device is a wireless optical computer mouse.

18. The self-inflating mouse device according to claim 17, wherein the sensor is an optical sensor.

19. The self-inflating mouse device according to claim 11, wherein the self-inflating mouse device is a wire mouse, the mouse body is connected with a cable, and the mouse body has a fillister for allowing the cable to penetrate through.

20. A self-inflating mouse device, comprising:
a mouse body, having a bottom surface, a side protrusion and a clicking part; and
an extension part, being expanded selectively and having a valve and an opening coupling with the side protrusion;
wherein the bottom surface of the mouse body has a sensor and the clicking part and the sensor are exposed out of the extension part when the side protrusion is coupled with the opening, and
wherein the valve intakes and exhausted air therethrough, and when the valve is close, shape of the extension part keeps unchanged, and when the valve is open, the air is exhausted from the extension part by pressing the extension part flat as a compact form.
